(19) United States
(12) Patent Application Publication
(10) Pub. No.: US 2007/0056689 A1
(43) Pub. Date: Mar. 15, 2007

(54) Adhesive application device and method for optical elements

(75) Inventor: Hsin-Ho Lee, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/411,721

(22) Filed: Apr. 26, 2006

(30) Foreign Application Priority Data
Sep. 9, 2005 (CN) 200510037216.6

(51) Int. Cl. C09J 5/00

(52) U.S. Cl. 156/305; 156/242; 425/542

(57) ABSTRACT

An apparatus (10) for applying adhesive to a plurality of components (12) includes a main body (20), a driving member (60) and an injecting device (80). The main body has a cavity (208) configured for receiving the components therein. The driving member is configured for pushing the components so as to make the components contact with each other. The injecting device has a receiving space (824) configured for containing an adhesive therein and at least one injecting hole (826) both communicating with the receiving space and the cavity thereby allowing the adhesive to be injected onto the components.

### BACKGROUND OF THE INVENTION

1. Field of the Invention

The present invention generally relates to adhesive application devices and, more particularly, to an adhesive application device for applying adhesive to optical elements, and also relates to a method for applying adhesive to the optical elements.

2. Discussion of the Related Art

With the rapid development of communication technology, mobile phones have become a commonplace communication tool in the life of people. In addition, with the rapid development of multimedia technology, digital still cameras and digital video cameras are now in widespread use. Moreover, most new designs for mobile phones nowadays also include digital cameras. Therefore, optical lenses are required more and more. Different from human eyes, an image sensors such as charge coupled devices (CCDs) or complementary metal oxide semiconductors (CMOS's) can sense infrared rays which cannot be sensed by human eyes. In order to obtain pictures same as images in human eyes, infrared rays should be filtered. Therefore, most optical lenses have an IR-cut (infrared ray cut) film.

Conventionally, optical lenses are cut into cuboid-shaped pieces after an IR-cut film has being applied thereon. Then the cuboid-shaped pieces are ground to circular-shaped corresponding to the shape of a tube. If the cuboid-shaped pieces are ground one by one, the efficiency is quite low. Thus, a plurality of cuboid-shaped pieces are generally machined together. The cuboid-shaped pieces are usually pasted together one by one and then ground all together. However, the quantity and the distribution of adhesive are unequal between each of two cuboid-shaped pieces, and the cuboid-shaped pieces are not symmetrically stacked to each other more or less. Thus, in the process of grinding, forces acting on the cuboid-shaped pieces differ from one cuboid-shaped piece to the next, which results that shapes of the optical lenses being different after ground. Therefore, many of the optical lenses are not good, giving a high rejection rate.

What is needed, therefore, is an adhesive application device which can promote the efficiency and qualification rate of machining optical elements.

### SUMMARY OF THE INVENTION

In one aspect, an apparatus for applying adhesive to a plurality of components comprises a main body, a driving member and an injecting device. The main body has a cavity configured for receiving the components therein. The driving member is configured for pushing the components so as to make the components contact with each other. The injecting device has a receiving space configured for containing an adhesive therein and at least one injecting hole both communicating with the receiving space and the cavity thereby allowing the adhesive to be injected onto the components.

In another aspect, a method for applying adhesive to a plurality of components is provided. According to one embodiment of the method, the components are firstly received in a cavity of a main body Secondly, the elements are moved so as to make the elements contact with each other. Thirdly, a predetermined amount of adhesive is injected from an injecting device onto the elements, whereby the elements are pasted together after the adhesive solidifies.

Other advantages and novel features of preferred embodiments of the present rocker will become more apparent from the following detailed description when taken in conjunction with the accompanying drawings.

### BRIEF DESCRIPTION OF THE DRAWINGS

Many aspects of the adhesive application device can be better understood with reference to the following drawings. The components in the drawings are not necessarily drawn to scale, the emphasis instead being placed upon clearly illustrating the principles of the adhesive application device. Moreover, in the drawings, like reference numerals designate corresponding parts throughout the several views.

FIG. 1 is an isometric view of an adhesive application device in accordance with a preferred embodiment showing a close state;

FIG. 2 is a cross-sectional view of the adhesive application device taken along line II-II of FIG. 1;

FIG. 3 is similar to FIG. 2, but taken along line III-III of FIG. 1; and

FIG. 4 is a cross-sectional view of the adhesive application device of FIG. 1 showing an open state.

### DETAILED DESCRIPTION OF PREFERRED EMBODIMENTS

An adhesive application device is provided for applying adhesive to a plurality of optical elements together to facilitate grinding the optical elements in a following working procedure.

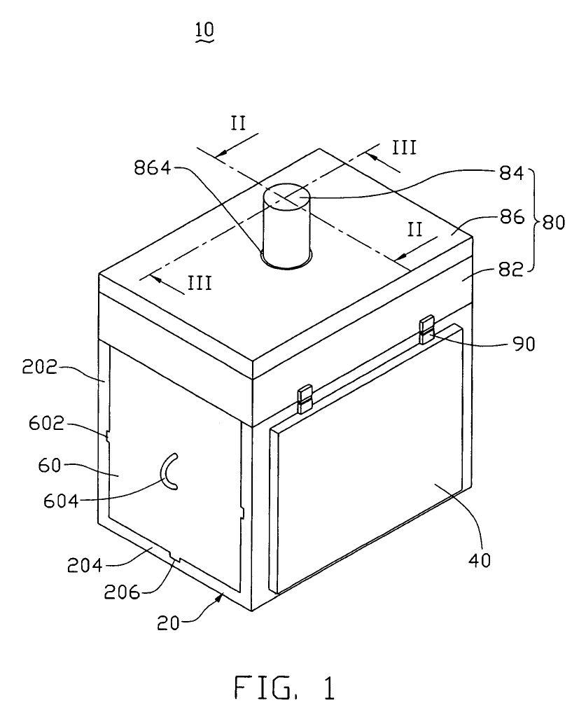

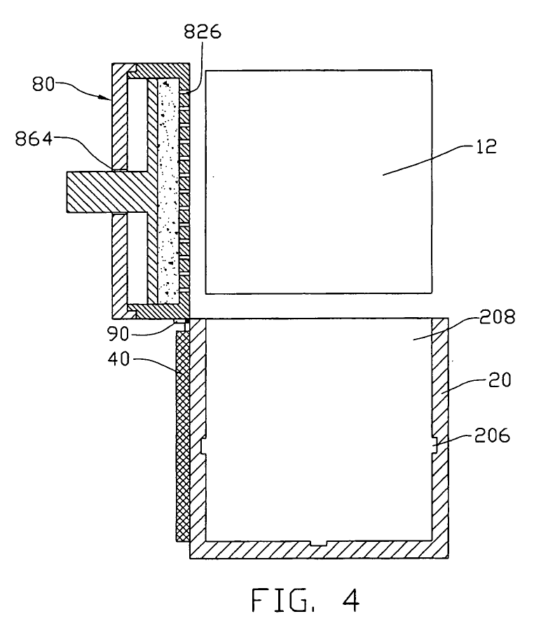

Referring to FIG. 1, the adhesive application device 10 includes a main body 20, a cooling plate 40, two moving boards 60, an injecting device 80, and two hinges 90. Shown in FIG. 4, Optical elements 12 are put into the adhesive application device 10 to paste together.

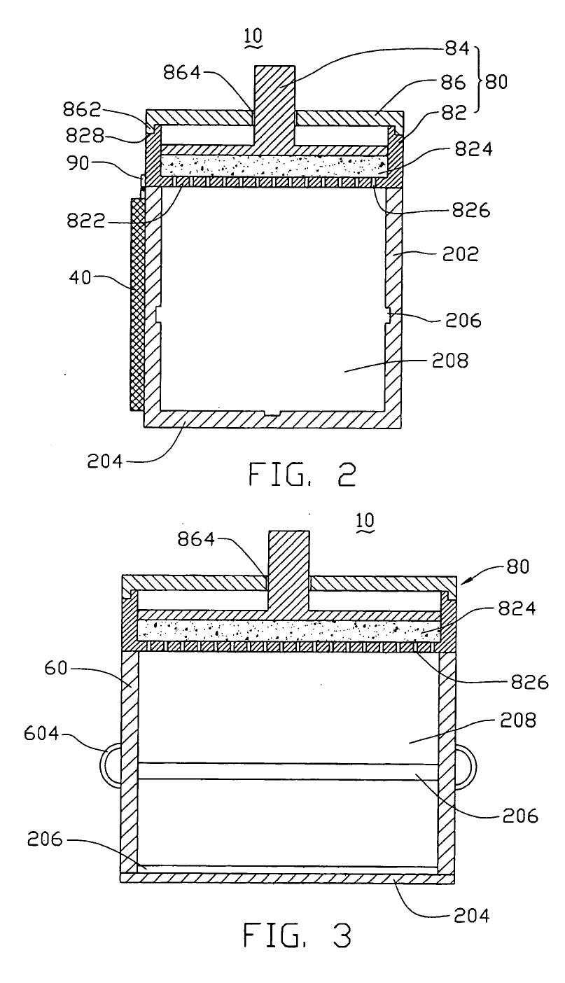

Also referring to FIG. 2 and FIG. 3, the main body 20 is a hollow cuboid including two opposite sidewalls 202 and a bottom board 204. Two ends of the bottom board 204 are perpendicularly connected to corresponding ends of the sidewalls 202. The sidewalls 202 and the bottom board 204 cooperatively define a cavity 208 therebetween. The main body 20 has two open sides (not labeled) perpendicular to the sidewalls 202 and the bottom board 204. Each of the sidewalls 202 and the bottom board 204 defines a guiding slot 206 in the middle portion thereof at an inner side. The guiding slots 206 are parallel to each other and communicate the open sides of the main body 20.

The cooling plate 40 is a rectangular-shaped board. The cooling plate 40 is fixed on an outer side of one of the sidewalls 202 by pasting with adhesive or other similar manners.

The moving boards 60 are rectangular-shaped. Three guiding protrusions 602 are respectively formed at three edges of each moving board 60. The moving boards 60 are set in the cavity 208 of the main body 20 and the guiding protrusions 602 each separately engages with their respective guiding slots 206. The moving boards 60 are slidable in the cavity 208 relative to the main body 20. Each moving board 60 has a handle 604 in the center of one side for facilitating manually removing the moving board 60.

The injecting device 80 includes a container 82, a piston 84 and a cover 86. The container 82 is a hollow cuboid with an open end and an opposite base 822. The container 82 has a receiving space 824 for receiving adhesive. A plurality of injecting holes 826 is evenly defined in the base 822. A rectangular-shaped slot 828 is defined in the container 82 at the open end. The cover 86 is rectangular-shaped. A rectangular-shaped flange 862 is formed on four edges of the cover 86. A through hole 864 is defined in the center of the cover 86. The cover 86 covers the open end of the container 82 and the flange 862 of the cover 86 engages with the slot 828 of the container 82. The piston 84 is T-shaped. The bottom portion of the piston 84 is set in the receiving space 824 and the head portion of the piston 84 protrudes out of the cover 86 via the through hole 864. The piston 84 is slidable in a direction of the axis of the through hole 864 relative to the container 82. The injecting device 80 is mounted on the main body 20 and is opposite to the bottom board 204. The injecting holes 826 face the main body 20 to communicate the cavity 208 of the main body 20 and the receiving space 824 of the container 82 so that adhesive in the receiving space 824 of the injecting device 80 can be injected into the cavity 208 of the main body 20.

The hinges 90 are used to rotatably connect the main body 20 and the container 80. The hinges 90 can be a door hinge with one part of the hinges 90 fixed to the main body 20 and other part of the hinges 90 fixed to the container 80. Thus, the container 80 can be closed or opened relative to the main body 20.

Referring to FIG. 4, in use, the cover 86 is opened and the piston 84 is taken out of the container 82. The piston 84 is remounted in the container 82 and the cover 86 is closed after pouring some adhesive into the container 84. Meanwhile, the injecting device 80 is opened and a plurality of optical elements 12 is arranged in parallel in the cavity 208 of the main body 20. Then at least one moving board 60 is pushed to move to push the optical elements 12 closer to each other so that each of the optical elements 12 contacts with an adjacent optical elements 12. Finally, the piston 84 is pushed towards the main body 20 to inject the adhesive out via the injecting holes 826 onto the optical elements 12. Thus, the optical elements 12 are pasted together after the adhesive solidifies. The cooling time will reduce with the help of the cooling plate 40. The adhesive is distributed on the optical elements 12 equally and the optical elements 12 identical in shape. Therefore, the quality of the optical elements 12 thus produced is high.

In an alternative embodiment, the cooling plate 40 can be omitted. The hinges 90 also can be omitted and the injecting device 80 is set on the main body 20 directly. One of the moving boards 60 can be fixed. The piston 84 and the moving boards 60 can both be driven by transmission mechanisms such as worm and worm wheel connected to motors to convert rotation to straight line motion. Thereby, the adhesive application device 10 runs automatically. The moving boards 60 can be two fixed boards which are fixed relative to the main body 20 and other driving members are provided to move the optical elements 12. For example, the driving members may be an elastic member such as a spring disposed on at least one of the moving boards 60. Alternatively, the driving member may also be another moving member operable to move between the two fixed boards. When the optical elements 12 are set in the cavity 208 of the main body 20, the elastic member resists and moves the optical elements 12.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claims:

1. A device for applying adhesive to a plurality of components, comprising:
a main body having a cavity with three sides, two of the three sides being opposite to each other, the cavity being configured for receiving the components;
two boards mounted at the two opposite sides respectively and at least one of the two boards being slidable in the cavity of the main body; and
an injecting device mounted at the other side of the main body, the injecting device having a receiving space configured for receiving adhesive and defining a plurality of injecting holes communicating the receiving space and the cavity and thus configured for injecting the adhesive onto the components.

2. The device as claimed in claim 1, wherein the device further comprises a cooling plate mounted outside the main body.

3. The device as claimed in claim 1, wherein the injecting device is pivotably mounted to the main body.

4. The device as claimed in claim 1, wherein the main body is hollow cuboid-shaped and the cavity is defined between two sidewalls perpendicular to the opposite sides, and another board opposite to the other side.

5. The device as claimed in claim 4, wherein the sidewalls and the another board each defines a guiding slot therein at an inner side, the guiding slots are parallel to each other and communicate the opposite two sides of the main body.

6. The device as claimed in claim 5, wherein the boards are rectangular-shaped, three guiding protrusions for engaging with the guiding slots are respectively formed at three edges of the slidable board.

7. The device as claimed in claim 1, wherein the injecting device comprises a container, a piston and a cover, the receiving space is defined in the container, the container has an open side and an opposite base evenly defining the injecting holes, the cover is mounted on the container for covering the open side of the container.

8. The device as claimed in claim 7, wherein the cover defines a through hole, the piston is T-shaped and slidable in a direction of the axis of the through hole relative to the container, the piston has a bottom portion set in the receiving space and a head portion protrudes out of the cover via the through hole.

9. The device as claimed in claim 7, wherein the container defines a slot at the open side and the cover forms a flange, the flange of the cover engages with the slot of the container.

10. A method for applying adhesive to a plurality of elements, comprising following steps:
receiving the elements into a cavity of a main body;
moving the elements so as to make the elements contact with each other; and
injecting a predetermined amount of adhesive from an injecting device onto the elements, whereby the elements are pasted together after the adhesive solidifies.

11. The method as claimed in claim 10, wherein the main body comprises a slidable board, and moving the elements is achieved by pushing the board into the cavity.

12. The method as claimed in claim 10, wherein the injecting device has a receiving space configured for receiving the adhesive, the receiving space is communicated with the cavity of the main body by a plurality of injecting holes, and the adhesive is injecting out via the injecting holes.

13. The method as claimed in claim 12, wherein the injecting device comprises a container, a piston and a cover, the receiving space is defined in the container, the injecting device has an open side covered by the cover and an opposite base evenly defining the injecting holes.

14. The method as claimed in claim 13, wherein the cover defines a through hole, the piston is T-shaped and slidable in a direction of the axis of the through hole relative to the container, the piston has a bottom portion set in the receiving space and a head portion protrudes out of the cover via the through hole, and injecting the adhesive is achieved by pushing the piston.

15. The method as claimed in claim 10, further comprising a step of cooling the adhesive by using a cooling plate located around the cavity.

16. An apparatus for applying adhesive to a plurality of components, the apparatus comprising:
a main body having a cavity configured for receiving the components therein;
a driving member being configured for pushing the components so as to make the components contact with each other; and
an injecting device having a receiving space configured for containing an adhesive therein, the injecting device having at least one injecting hole both communicating with the receiving space and the cavity thereby allowing the adhesive to be injected onto the components.

17. The apparatus as claimed in claim 16, further comprising a cooling member located adjacent to the cavity for cooling the adhesive.

18. The apparatus as claimed in claim 16, wherein the driving member is a plate member slidable into the cavity.

19. The apparatus as claimed in claim 16, wherein the driving member is a moving member slidable into the cavity.
